(19) United States
(12) Patent Application Publication
(10) Pub. No.: US 2023/0354101 A1
(43) Pub. Date: Nov. 2, 2023

(54) RESOURCE ALLOCATION DEVICE, RESOURCE ALLOCATION METHOD, AND CONTROL CIRCUIT

(71) Applicant: Mitsubishi Electric Corporation, Tokyo (JP)

(72) Inventors: Akiko IWASAKI, Tokyo (JP); Kenichi NAKURA, Tokyo (JP); Takeshi SUEHIRO, Tokyo (JP)

(73) Assignee: Mitsubishi Electric Corporation, Tokyo (JP)

(21) Appl. No.: 18/213,098

(22) Filed: Jun. 22, 2023

Related U.S. Application Data
(63) Continuation of application No. PCT/JP2021/004431, filed on Feb. 5, 2021.

(51) Int. Cl. H04W 28/16

(52) U.S. Cl. CPC H04W 28/16

(57) ABSTRACT

A resource allocation device includes: a required resource calculation unit that calculates, for each slice, a required occupation value and a required share value based on a predicted value and prediction accuracy of traffic generated in each of one or more slices generated between a host pair of a higher device and a lower device, and calculates a total required occupation value and a total required share value on a host pair basis based on the required occupation value and the required share value calculated; and a resource allocation unit that determines, for each host pair, whether the total required occupation value and the total required share value are allowed to be allocated to the host pair based on an available resource, and allocates the required occupation value and the required share value to each slice in a case where the allocation is possible.

### CROSS-REFERENCE TO RELATED APPLICATION

This application is a continuation application of International Application PCT/JP2021/004431, filed on Feb. 5, 2021, and designating the U.S., the entire contents of which are incorporated herein by reference.

### BACKGROUND OF THE INVENTION

### 1. Field of the Invention

The present disclosure relates to a resource allocation device, a resource allocation method, a control circuit, and a storage medium.

### 2. Description of the Related Art

In recent years, diversification of services has resulted in a demand for constructing a network that meets various service requirements. In order to implement such a network, a scheme for constructing slices, which are logically divided virtual networks, on a single physical network has been studied. The slices are implemented by dividing the physical network into a plurality of logical networks and allocating communication resources (hereinafter simply referred to as “resources”) that satisfy requirements of accommodated services to the logical networks.

In order to efficiently use the limited resources, it is considered effective to dynamically allocate the resources to the slices based on prediction of traffic demand, instead of fixedly allocating the resources to the slices. However, the prediction of traffic demand is assumed to have accuracy that varies depending on an application type, a prediction method, or the like. Therefore, the resource allocation performed according to prediction information with low accuracy possibly results in excessive allocation or insufficient allocation of the resources in a case where a deviation of the prediction information from an actual rate is large. Thus, in such case, the efficiency of resource utilization of the entire network may be reduced.

In response to this problem, Japanese Patent No. 5742981 proposes a resource allocation method of classifying traffic into traffic that is predictable and traffic that is difficult to predict, thereby allocating resources based on a prediction result to the traffic that is predictable and allocating, to the traffic that is difficult to predict, residual resources so that the load of a link is leveled without using a predicted value.

However, the technique of Japanese Patent No. 5742981 above has a problem that the traffic that is difficult to predict is handled depending on best-effort. If the resources can be allocated according to the level of predictability also to the traffic that is difficult to predict, it is possible to further increase the efficiency of resource utilization.

The present disclosure has been made in view of the above, and an object thereof is to provide a resource allocation device capable of increasing the efficiency of resource utilization.

### SUMMARY OF THE INVENTION

In order to solve the above-described problems and achieve the object, the present disclosure is a resource allocation device including: a required resource calculation unit to calculate, for each slice, a required occupation value and a required share value based on a predicted value and prediction accuracy of traffic generated in each of one or more slices generated between a host pair that is a pair of a higher device and a lower device, and calculate a total required occupation value and a total required share value on a host pair basis based on the required occupation value and the required share value calculated, the required occupation value being a resource to be occupied and used by each slice, and the required share value being a resource to be shared and used between the slices; and a resource allocation unit to determine, for each of the host pair, whether or not the total required occupation value and the total required share value are allowed to be allocated to the host pair based on an available resource, and allocate the required occupation value and the required share value to each slice in a case where the allocation is possible.

### BRIEF DESCRIPTION OF THE DRAWINGS

FIG. 1 is a diagram illustrating an example of a configuration of a communication system according to a first embodiment;

FIG. 2 is a diagram illustrating a functional configuration of a resource allocation device according to the first embodiment;

FIG. 3 is a diagram illustrating a hardware configuration of the resource allocation device according to the first embodiment;

FIG. 4 is a flowchart illustrating an example of a resource allocation operation by the resource allocation device according to the first embodiment;

FIG. 5 is a diagram illustrating an example of prediction information received from an orchestrator by the resource allocation device according to the first embodiment;

FIG. 6 is a diagram illustrating an example of a required resource management table;

FIG. 7 is a first diagram illustrating an example of a resource management table;

FIG. 8 is a second diagram illustrating an example of the resource management table; and

FIG. 9 is a diagram illustrating a functional configuration of a resource allocation device according to a second embodiment.

### DETAILED DESCRIPTION OF THE PREFERRED EMBODIMENTS

Hereinafter, a resource allocation device, a resource allocation method, a control circuit, and a storage medium according to embodiments of the present disclosure will be described in detail with reference to the drawings.

### First Embodiment

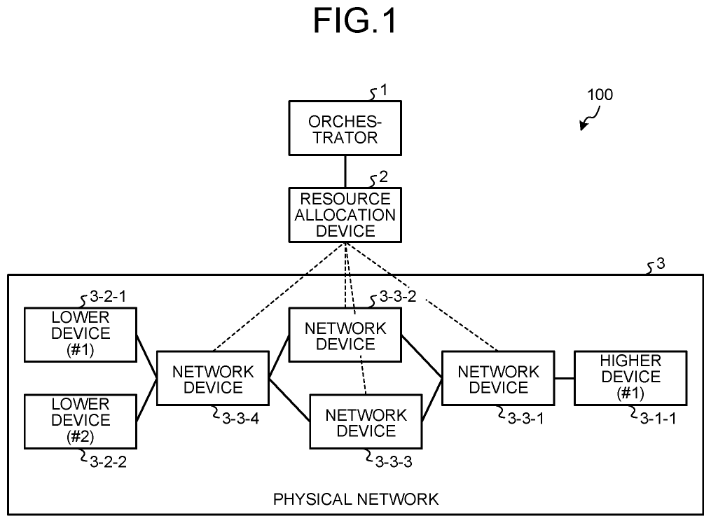

FIG. 1 is a diagram illustrating an example of a configuration of a communication system 100 according to a first embodiment. The communication system 100 according to the first embodiment includes an orchestrator 1, a resource allocation device 2, and a physical network 3. The physical network 3 includes a higher device 3-1-1, a plurality of lower devices 3-2-1 and 3-2-2, and a plurality of network devices 3-3-1 to 3-3-4. The higher device 3-1-1 is, for example, a server device, and the lower devices 3-2-1 and 3-2-2 are, for example, client devices. Note that the number of devices included in the physical network 3 is an example. That is, the number of the higher devices may be two or more, and the number of the lower devices may be one or three or more. The same applies to the number of the network devices.

In the following description, a pair of any one of the higher devices and any one of the lower devices is referred to as a host pair. Also, for convenience of description, the higher device 3-1-1 may be referred to as a higher device #1, and the lower device 3-2-1 and the lower device 3-2-2 may be referred to as a lower device #1 and a lower device #2, respectively.

The orchestrator 1 has a function of notifying the resource allocation device 2 of a slice operation request. The slice operation request is an interface for requesting the resource allocation device 2 to generate, update, and delete a slice. For example, in a case where the slice operation request is a request to generate a slice, the slice operation request includes at least a slice identifier (ID) of the slice to be generated, a slice generation time, and one or more pieces of host pair information between which the slice is to be generated. The host pair information includes at least information on the higher device, the lower device, and a rate requirement. The rate requirement is a requirement of a communication rate in the slice generated between the host pair. The slice operation request for requesting update of a slice includes at least a slice ID of the slice to be updated and host pair information. The slice operation request for requesting deletion of a slice includes at least a slice ID of the slice to be deleted and host pair information.

In addition, the orchestrator 1 has a function of notifying the resource allocation device 2 of prediction information. The prediction information includes information on one or more prediction models. The prediction model includes at least a prediction model ID, a slice ID, information of a host pair, and one or more pieces of information of a prediction result. The prediction model ID is an ID for uniquely identifying a pair of the slice ID and the host pair. That is, the prediction information indicates the prediction result for each slice of traffic generated in each of one or more of the slices generated between each host pair. The prediction result includes at least information on a prediction time, a predicted value, and prediction accuracy.

The prediction accuracy is a value representing the accuracy of prediction. For example, the prediction accuracy may be mean and standard deviation values of a probability distribution of the predicted values, or may be a value indicating a probability of taking the predicted value. The prediction accuracy may include a plurality of values representing the prediction accuracy. Moreover, the prediction accuracy may be represented on a prediction model basis, a slice basis, or a host pair basis. That is, the prediction accuracy may be calculated for each prediction model, for each slice, or for each host pair.

The resource allocation device 2 has a function of allocating a resource satisfying the requirement to the slice based on the slice operation request received from the orchestrator 1, and notifying the physical network 3 of the resource allocated. In addition, the resource allocation device 2 has a function of performing resource allocation based on the prediction information received from the orchestrator 1 and notifying the physical network 3 of the resource allocated.

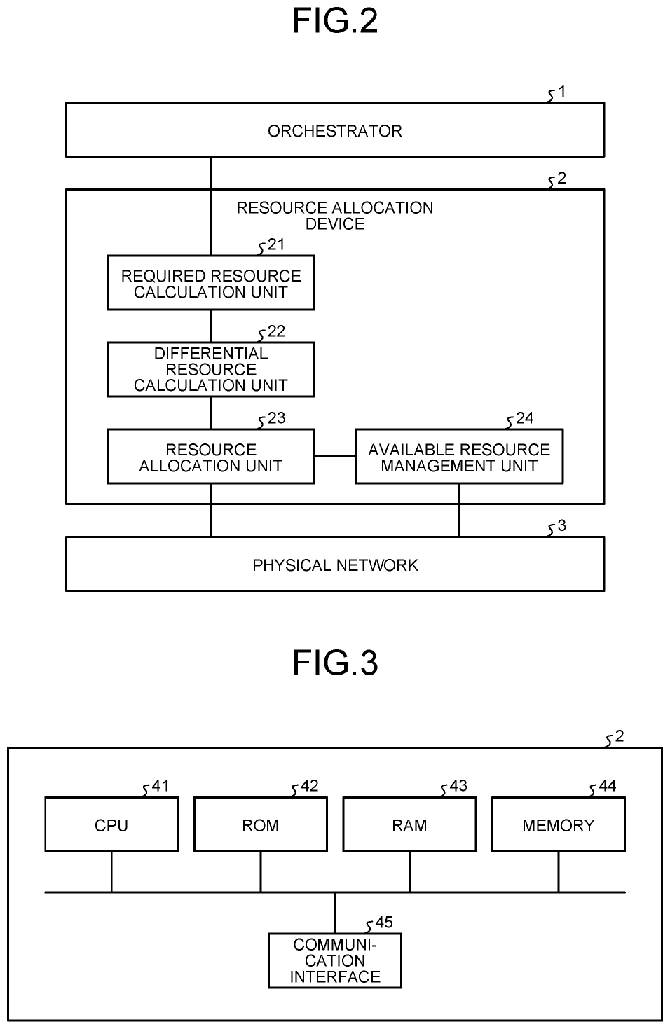

FIG. 2 is a diagram illustrating a functional configuration of the resource allocation device 2 according to the first embodiment. The resource allocation device 2 includes a required resource calculation unit 21, a differential resource calculation unit 22, a resource allocation unit 23, and an available resource management unit 24.

The required resource calculation unit 21 calculates a required occupation value and a required share value for each prediction model based on the prediction information received from the orchestrator 1. Specifically, the required resource calculation unit 21 calculates the required occupation value and the required share value based on the prediction accuracy for each prediction model. The required occupation value is a value of a resource that can be occupied and used by each slice. The required share value is a value of a resource that can be shared and used between a plurality of slices. For example, there is a case where a first slice uses a part of the required share value, and a second slice uses the rest. By allocating a large part of the required share value to a slice with low prediction accuracy, a surplus resource can be used in another slice even in a case where there is a large difference between a predicted rate and an actual rate, which results in an effect that the resources are not wasted.

An example of a method of calculating the required occupation value and the required share value based on a value representing the prediction accuracy will be described below.

As a first example, a description will be made of an example of calculating the required occupation value and the required share value in a case where information on a probability distribution of predicted values conforming to a normal distribution is given as the prediction accuracy. The information on the probability distribution is a mean and a standard deviation. If the mean and the standard deviation of the predicted values are known, a probability of occurrence of each traffic value can be estimated, so that an allocation amount based on the probability of occurrence can be determined. As an example, the required occupation value may be calculated as “mean-(standard deviation×N)”, and the required share value may be calculated as “standard deviation×M”. The required occupation value and the required share value may be calculated by another method using at least one of the mean and the standard deviation.

As a second example, in a case where a probability of taking the predicted value is given as the prediction accuracy, the required occupation value may be calculated as “predicted value×probability of taking the predicted value”, and the required share value may be calculated as “predicted value-required occupation value”. The required occupation value and the required share value may be calculated by another method using the value of the probability of taking the predicted value.

Moreover, the required resource calculation unit 21 registers the calculated required occupation value and required share value in a required resource management table. The required resource management table includes at least a slice ID at each time and the required occupation value and the required share value on a host pair basis.

Furthermore, based on the required occupation value and the required share value calculated on a prediction model basis, the required resource calculation unit 21 calculates a total required occupation value and a total required share value on a host pair basis. The required resource calculation unit 21 calculates “the total required occupation value” as a sum of the required occupation values of the prediction models, and calculates “the total required share value” as an average of the required share values of the prediction models. The total required occupation value and the total required share value may be determined by another method. For example, the total required share value may be a total value of the required share values of the prediction models, or may be a value obtained by multiplying the total value of the required share values of the prediction models by a weighting coefficient corresponding to the number of slices.

The differential resource calculation unit 22 calculates a total required value by adding the total required occupation value and the total required share value on a host pair basis calculated by the required resource calculation unit 21. The differential resource calculation unit 22 further calculates a total additional value by adding a total additional occupation value and a total additional share value on a host pair basis. The total additional occupation value and the total additional share value are the total required occupation value and the total required share value calculated by the required resource calculation unit 21 in the previous resource allocation processing, respectively. Furthermore, the differential resource calculation unit 22 calculates a difference between the total required value and the total additional value, and notifies the resource allocation unit 23 of a result of the calculation as a differential resource.

The resource allocation unit 23 determines whether the differential resource received from the differential resource calculation unit 22 can be allocated to the host pair by using information of an available resource on a host pair basis managed by the available resource management unit 24. If determining that the differential resource can be allocated, the resource allocation unit 23 allocates, to the slices, the required occupation value for each slice and the total required share value as a resource to be shared between the slices. The resource to be shared between the slices is a resource that can be commonly used by the slices. If determining that the differential resource cannot be allocated, the resource allocation unit 23 allocates the required occupation value for each slice to the slice with the prediction accuracy higher than or equal to a threshold among the slices in descending order of prediction accuracy. Moreover, the resource allocation unit 23 allocates, to the remaining slice to which the resource has not been allocated, a surplus resource obtained by subtracting the above-described allocated resource from the available resource as a resource to be shared between the slices.

In addition, the resource allocation unit 23 notifies the physical network 3 of the resource allocated to each slice. Specifically, the resource allocation unit 23 notifies the network devices 3-3-1 to 3-3-4 included in the physical network 3 of the resource allocated to each slice. Moreover, the resource allocation unit 23 registers the total required occupation value and the total required share value, which are allocated to each host pair, in the total additional occupation value and the total additional share value in a resource management table, respectively. The resource management table is a table for managing, as objects of management, at least the total required occupation value, the total required share value, the total additional occupation value, and the total additional share value on a host pair basis at each time.

The available resource management unit 24 acquires information on an available resource from the physical network 3, and calculates and manages the available resource for each host pair based on the acquired information.

FIG. 3 is a diagram illustrating a hardware configuration of the resource allocation device 2 according to the first embodiment. The resource allocation device 2 includes a central processing unit (CPU) 41, a read only memory (ROM) 42, a random access memory (RAM) 43, a memory 44, and a communication interface 45. These components are connected via a bus.

The CPU 41 is responsible for overall processing and control of the resource allocation device 2. The ROM 42 stores programs such as a boot program, a communication program, and a data analysis program. The RAM 43 is used as a work area of the CPU 41. The communication interface 45 is connected to the orchestrator 1 and the physical network 3.

Moreover, the required resource calculation unit 21, the differential resource calculation unit 22, the resource allocation unit 23, and the available resource management unit 24 of the resource allocation device 2 are implemented by software, firmware, or a combination of software and firmware. The software or firmware for implementing each component of the resource allocation device 2 is described as a program and stored in the memory 44. The CPU 41 implements the function of each component of the resource allocation device 2 by reading and executing the program stored in the memory 44. Note that the program described above is stored in advance in the memory 44, but may alternatively be written on a storage medium such as a compact disc (CD)-ROM or a digital versatile disc (DVD)-ROM to be supplied to a user and installed in the memory 44 by the user.

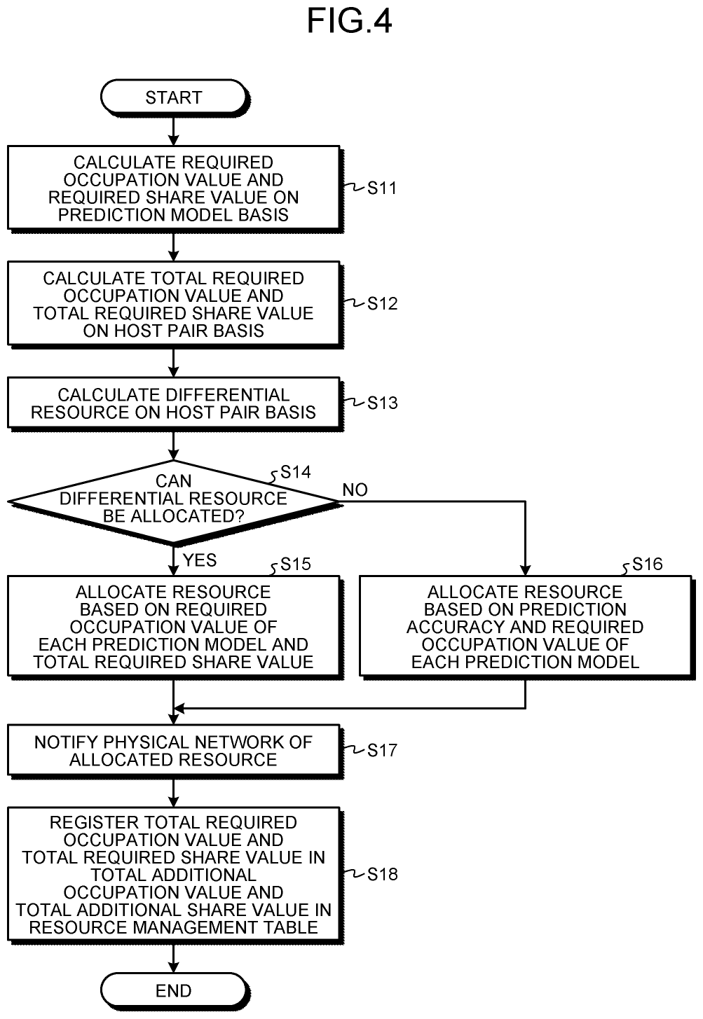

Next, a flow in which the resource allocation device 2 performs resource allocation will be described with reference to FIG. 4. FIG. 4 is a flowchart illustrating an example of a resource allocation operation by the resource allocation device 2 according to the first embodiment. The resource allocation device 2 is assumed to have received a slice operation request from the orchestrator 1 in advance and generate slices with slice IDs “1” and “2”. The requirements of the slice ID “1” are assumed to be 100 Mbps for the higher device #1 and the lower device #1 and 100 Mbps for the higher device #1 and the lower device #2, and the requirements of the slice ID “2” are assumed to be 100 Mbps for the higher device #1 and the lower device #1 and 100 Mbps for the higher device #1 and the lower device #2. In the resource management table at this time, the total required occupation value, the total required share value, the total additional occupation value, and the total additional share value are all assumed to be zero.

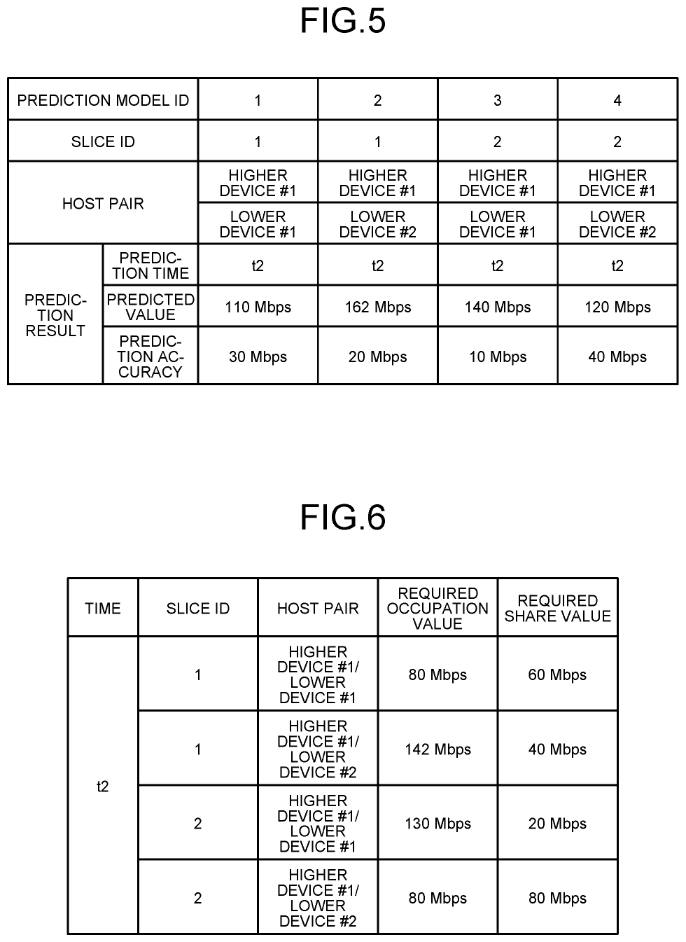

First, when receiving prediction information from the orchestrator 1, the resource allocation device 2 calculates a required occupation value and a required share value at a prediction time for each prediction model based on a prediction result (step S11). The required occupation value and the required share value are calculated by the required resource calculation unit 21. The required resource calculation unit 21 calculates the required occupation value and the required share value for each slice. The required resource calculation unit 21 registers the required occupation value and the required share value calculated for each slice in the required resource management table. This operation will be described in detail. For example, it is assumed that the resource allocation device 2 has received the prediction information having the details illustrated in FIG. 5. Note that FIG. 5 is a diagram illustrating an example of the prediction information that the resource allocation device 2 according to the first embodiment receives from the orchestrator 1. In the example illustrated in FIG. 5, the standard deviation of the predicted value is used as the prediction accuracy. In this case, for the slice with a prediction model ID “1” (the slice with the slice ID “1” for the host pair of the higher device #1 and the lower device #1), the required resource calculation unit 21 of the resource allocation device 2 calculates the required occupation value at prediction time t2 as “(predicted value)−(prediction accuracy)” (i.e. 110 Mbps−30 Mbps=80 Mbps), and calculates the required share value as “(prediction accuracy)×2” (i.e. 30 Mbps×2=60 Mbps). The required resource calculation unit 21 similarly calculates the required occupation value and the required share value for the slices of other prediction model IDs, and registers results of the calculation (the required occupation values and the required share values) in the required resource management table. FIG. 6 illustrates the required resource management table after the results of the calculation for the slices of the prediction model IDs are registered. FIG. 6 is the diagram illustrating an example of the required resource management table.

The required resource calculation unit 21 may calculate the required occupation value and the required share value every time the prediction information is received, or only when the predicted value at an arbitrary prediction time exceeds the requirement specified in the slice operation request. Also, a threshold may be set for determining whether or not the predicted value exceeds the requirement. For example, in a case of the requirement set to 100 Mbps and the threshold set to 10 Mbps, the predicted value may be determined to exceed the requirement if the predicted value is 110 Mbps or more.

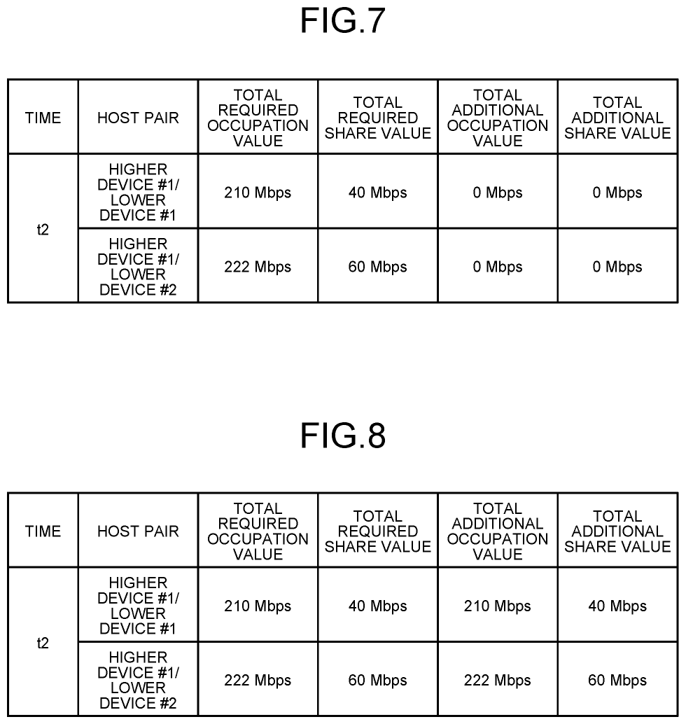

Next, the resource allocation device 2 calculates a total required occupation value and a total required share value on a host pair basis (step S12). The total required occupation value and the total required share value on a host pair basis are calculated by the required resource calculation unit 21. The required resource calculation unit 21 registers the calculated total required occupation value and total required share value in the resource management table. In the present example, the total required occupation value is calculated as a total value of the required occupation values of the prediction models, and the total required share value is calculated as an average value of the required share values of the prediction models. From the required resource management table illustrated in FIG. 6, the total required occupation value for the host pair of the higher device #1 and the lower device #1 is a total value (210 Mbps) of the required occupation value (80 Mbps) for the slice ID “1” and the required occupation value (130 Mbps) for the slice ID “2”. Also, the total required share value for the host pair of the higher device #1 and the lower device #1 is an average value (40 Mbps) of the required share value (60 Mbps) for the slice ID “1” and the required share value (20 Mbps) for the slice ID “2”. Similarly, the total required occupation value and the total required share value for the other host pair are calculated and registered in the resource management table as illustrated in FIG. 7. FIG. 7 is a first diagram illustrating an example of the resource management table.

Next, the resource allocation device 2 calculates a differential resource on a host pair basis (step S13). The differential resource is calculated by the differential resource calculation unit 22. This operation will be described in detail. In a case where a state of the resource management table after the execution of step S12 above is that as illustrated in FIG. 7, for the host pair of the higher device #1 and the lower device #1, the differential resource calculation unit 22 first adds the total required occupation value (210 Mbps) and the total required share value (40 Mbps) to calculate a total required value (250 Mbps). The differential resource calculation unit 22 further adds the total additional occupation value and the total additional share value to calculate a total additional value. However, in a case where there is a slice that has not been previously subjected to resource allocation based on the prediction information, a requirement of the slice, that is, a value currently allocated to the slice based on the slice operation request, is added to the total additional value calculated above. In the case of the present example, since the slice ID “1” and the slice ID “2” have not been previously subjected to resource allocation based on the prediction information, the requirements of the slices (100 Mbps for both the slice ID “1” and the slice ID “2”) are added to the total additional value. The differential resource calculation unit 22 further calculates a differential resource (50 Mbps) between the total required value (250 Mbps) and the total additional value (200 Mbps). Also for the host pair of the higher device #1 and the lower device #2, the differential resource calculation unit 22 calculates the differential resource (82 Mbps) by a similar method.

Next, the resource allocation device 2 determines whether or not the differential resource can be allocated for each host pair based on the available resource (step S14). The determination of whether or not the differential resource can be allocated in step S14 and the processing in steps S15 and S16 described later are performed on a host pair basis. That is, in the present example, the processing in steps S14 to S16 is executed for each of the host pair of the higher device #1 and the lower device #1 and the host pair of the higher device #1 and the lower device #2 to allocate the resources to the slices. Note that the processing in steps S14 to S16 is performed by the resource allocation unit 23.

The present embodiment will describe, as an example, a case where the resources are allocated by executing steps S14 to S16 with respect to the host pair of the higher device #1 and the lower device #1. In step S14 performed on the host pair of the higher device #1 and the lower device #1, the resource allocation unit 23 determines that the differential resource can be allocated if the available resource is 50 Mbps or more, or determines that the differential resource cannot be allocated if the available resource is less than 50 Mbps.

If the differential resource can be allocated (Yes in step S14), the resource allocation unit 23 allocates the resources to the host pair of the higher device #1 and the lower device #1 based on the required occupation value of each prediction model and the total required share value (step S15). Specifically, the resource allocation unit 23 allocates the required occupation value to each slice, and further allocates the total required share value to all the slices. More specifically, according to the required resource management table illustrated in FIG. 6, the resource allocation unit 23 allocates 80 Mbps as the required occupation value to the slice with the slice ID “1” for the host pair of the higher device #1 and the lower device #1, and allocates 130 Mbps as the required occupation value to the slice with the slice ID “2” for the same host pair. Moreover, according to the resource management table illustrated in FIG. 7, the resource allocation unit 23 allocates 40 Mbps, which is the total required share value, as the resource to be shared between the slices, to the slice with the slice ID “1” and the slice with the slice ID “2” for the host pair of the higher device #1 and the lower device #1.

Meanwhile, if the differential resource cannot be allocated (No in step S14), the resource allocation unit 23 allocates the resources to the host pair of the higher device #1 and the lower device #1 based on the prediction accuracy and the required occupation value of each prediction model (step S16). Specifically, of the slices set for the host pair of the higher device #1 and the lower device #1, the resource allocation unit 23 first allocates the required occupation value to each slice with the prediction accuracy satisfying a predetermined threshold in descending order of the prediction accuracy. The resource allocation unit 23 then allocates, to each slice to which the resource has not been allocated, an unused resource that is a surplus resource obtained by subtracting the above-described resource allocated as the required occupation value from the available resource, as a resource to be shared between the slices.

Although the description has been made of the operation in the case of executing steps S14 to S16 for the host pair of the higher device #1 and the lower device #1, a similar operation is performed in the case of executing steps S14 to S16 for the host pair of the higher device #1 and the lower device #2.

After executing steps S14 to S16 for all the host pairs and completing resource allocation, the resource allocation unit 23 notifies the physical network 3 of the allocated resources (step S17).

Next, the resource allocation unit 23 registers the total required occupation value and the total required share value in the total additional occupation value and the total additional share value in the resource management table (step S18), and ends the resource allocation operation. That is, the resource allocation unit 23 registers the total required occupation value in the total additional occupation value in the resource management table, and registers the total required share value in the total additional share value in the resource management table. As a result, the resource management table is updated to be in a state illustrated in FIG. 8. FIG. 8 is a second diagram illustrating an example of the resource management table.

As described above, in the resource allocation device 2 according to the first embodiment, the required resource calculation unit 21 calculates the required occupation value and the required share value in each slice based on the predicted value of the traffic generated at the time when the resource allocation is performed and the prediction accuracy, and further calculates the total required occupation value and the total required share value on a host pair basis. The differential resource calculation unit 22 calculates, for each of the host pairs, the differential resource that is a difference between the added result (total required value) of the total required occupation value and the total required share value, and the added result (total additional value) of the total additional occupation value and the total additional share value that are the total required occupation value and the total required share value obtained at the time of the previous resource allocation. The resource allocation unit 23 determines whether or not the total required occupation value and the total required share value can be allocated based on the available resource, which is the unused resource not allocated to the slice, and the differential resource, and allocates the required occupation value and the required share value to each slice if the allocation is possible. If unable to allocate the total required occupation value and the total required share value, the resource allocation unit 23 allocates the resource of the required occupation value to a certain number of the slices with high prediction accuracy of the predicted value of the traffic generated in each slice, and allocates the remaining unused resource to the remaining slices as the resource to be shared between the slices. As a result, the communication system 100 including the resource allocation device 2 can use the resources more efficiently and more flexibly.

### Second Embodiment

The resource allocation device 2 according to the first embodiment acquires the prediction accuracy from the outside, whereas a resource allocation device 2a according to a second embodiment internally calculates the prediction accuracy.

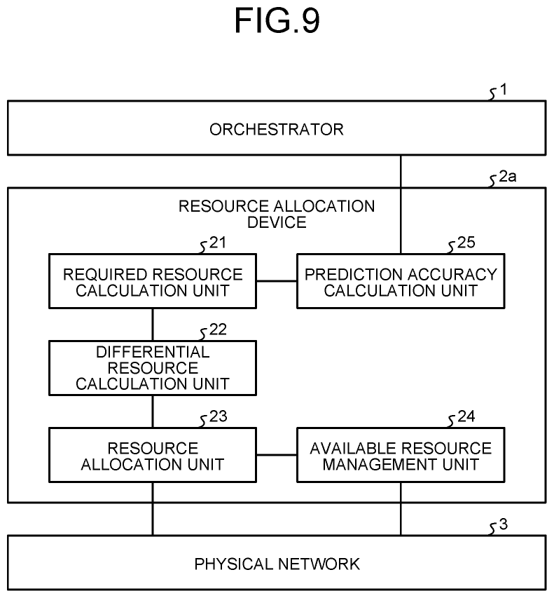

FIG. 9 is a diagram illustrating a functional configuration of the resource allocation device 2a according to the second embodiment. As illustrated in FIG. 9, the resource allocation device 2a according to the second embodiment has a configuration in which a prediction accuracy calculation unit 25 is added to the resource allocation device 2 according to the first embodiment. Since the functional configuration of the resource allocation device 2a other than the prediction accuracy calculation unit 25 is the same as that of the resource allocation device 2 described in the first embodiment, the description thereof will be omitted. Note that, in the present embodiment, the prediction accuracy need not be included in the prediction information transmitted from the orchestrator 1 to the resource allocation device 2a.

The prediction accuracy calculation unit 25 of the resource allocation device 2a calculates the prediction accuracy according to the content of the prediction information received from the orchestrator 1. For example, in a case where predicted values at a single prediction time are received a plurality of times as the prediction information, that is, in a case where the prediction is performed a plurality of times for the single prediction time, the prediction accuracy calculation unit 25 may calculate a mean and a standard deviation as information of a probability distribution based on the plurality of predicted values at the single prediction time. For example, when the number of data is “n”, each predicted value is “xᵢ”, and a mean of the predicted values is “x′”, the prediction accuracy calculation unit 25 calculates a standard deviation “s” using the following expression (1).

$$Formula 1$$

$$s = \sqrt{\frac{1}{n} {\sum }_{i = 1}^{n} {( {x}_{i} - {x}^{′} )}^{2}} \qquad ( 1 )$$

Moreover, in a case of receiving predicted values at a plurality of past and future prediction times as the prediction information, the prediction accuracy calculation unit 25 may calculate a moving average and a standard deviation based on the plurality of past and future predicted values. For example, when the number of data is “n” (e.g., n=2K+1 where “K” is a natural number) and reference data of a predicted value is “xᵢ”, the prediction accuracy calculation unit 25 calculates a moving average “maᵢ” by using the following expression (2).

$$Formula 2$$

$${ma}_{i} = \frac{1}{n} \{ {x}_{i} + {\sum }_{j = 1}^{k} ( {x}_{i - j} + {x}_{i + j} ) \} \qquad ( 2 )$$

As described above, the resource allocation device 2a according to the second embodiment further includes the prediction accuracy calculation unit 25 that calculates the prediction accuracy based on the predicted values included in the prediction information received. As a result, even in a case where the prediction information received from the orchestrator 1 does not include the prediction accuracy, the prediction accuracy can be calculated. Therefore, with the use of the prediction accuracy calculated, the resources can be allocated to the slices by a method similar to that of the resource allocation device 2 according to the first embodiment, and an effect similar to that of the resource allocation device 2 according to the first embodiment can be obtained.

Note that when calculating the required occupation value and the required share value using the mean and the standard deviation of the predicted values, the required resource calculation unit 21 described above may perform weighting according to a ratio between the requirement and the mean to calculate the required occupation value and the required share value. This can prevent excessive allocation of resources to the slice in a case where the prediction accuracy is high but a difference between the requirement and the predicted value is large. For example, when the ratio “mean/requirement” (D) is 1<D≤1.2, the required occupation value may be calculated as “(mean)−(standard deviation)” and the required share value may be calculated as “2×(standard deviation)”, and when 1.2<D<1.5, the required occupation value may be calculated as “(mean)−2×(standard deviation)” and the required share value may be calculated as “2×(standard deviation)”.

Moreover, when calculating the required occupation value and the required share value, the required resource calculation unit 21 may calculate the required occupation value and the required share value based on a preset correspondence relation between a value of the prediction accuracy (or a range of the prediction accuracy, or the like) and an allocation amount at that time (distribution of allocation of the required occupation value and the required share value, or the like). As a result, an operator or the like can determine a method of calculating the required occupation value and the required share value, and more flexible resource allocation can be performed.

Moreover, the required resource calculation unit 21 may perform weighting based on a request delay value of a slice on the required occupation value and the required share value calculated based on the prediction accuracy, and may generate final required occupation value and required share value. As a result, the resources can be preferentially allocated to a slice having a high request delay value.

Alternatively, the required resource calculation unit 21 may perform weighting in accordance with a request availability value of a slice on the required occupation value and the required share value calculated based on the prediction accuracy, and may generate final required occupation value and required share value. As a result, the resources can be preferentially allocated to a slice having a high request availability value.

Moreover, when obtaining a total share value, the required resource calculation unit 21 may calculate the maximum value among the required share values of the slices as the total share value.

Moreover, if determining that the differential resource cannot be allocated, the resource allocation unit 23 described above may preferentially allocate the required occupation value and the required share value to a slice with a strict delay request. As a result, the resources can be preferentially allocated to a slice having a high request delay value.

Alternatively, if determining that the differential resource cannot be allocated, the resource allocation unit 23 may preferentially allocate the required occupation value and the required share value to a slice with a high set priority. As a result, the resources can be preferentially allocated to a slice having a high priority.

Alternatively, if determining that the differential resource cannot be allocated, the resource allocation unit 23 may preferentially allocate the required occupation value and the required share value to a slice with a high request availability value. As a result, the resources can be preferentially allocated to a slice having a strict availability request.

Alternatively, if determining that the differential resource cannot be allocated, the resource allocation unit 23 may preferentially allocate the required occupation value and the required share value to a slice with a small ratio between the requirement and the mean. This as a result can prevent excessive allocation of resources to the slice.

The resource allocation device according to the present disclosure has an effect of being able to increase the efficiency of resource utilization.

The configurations illustrated in the above embodiments merely illustrate an example so that another known technique can be combined thereto, the embodiments can be combined together, or the configurations can be partially omitted and/or modified without departing from the scope of the present disclosure.

1. A resource allocation device comprising:
required resource calculation circuitry to calculate, for each slice, a required occupation value and a required share value based on a predicted value and prediction accuracy of traffic generated in each of one or more slices generated between a host pair that is a pair of a higher device and a lower device, and calculate a total required occupation value and a total required share value on a host pair basis based on the required occupation value and the required share value calculated, the required occupation value being a resource to be occupied and used by each slice, and the required share value being a resource to be shared and used between the slices; and
resource allocation circuitry to determine, for each of the host pair, whether or not the total required occupation value and the total required share value are allowed to be allocated to the host pair based on an available resource, and allocate the required occupation value and the required share value to each slice in a case where the allocation is possible.

2. The resource allocation device according to claim 1, wherein
the prediction accuracy is information represented by a mean of a probability distribution of the predicted value and a standard deviation of the predicted value, and
the required resource calculation circuitry calculates the required occupation value and the required share value of each slice based on the mean and the standard deviation.

3. The resource allocation device according to claim 2, wherein
the required resource calculation circuitry calculates the mean as the required occupation value, and calculates a result obtained by multiplying the standard deviation by two as the required share value.

4. The resource allocation device according to claim 2, wherein
the required resource calculation circuitry calculates the required occupation value and the required share value by performing weighting based on a ratio between a resource requirement and the mean.

5. The resource allocation device according to claim 1, wherein
the prediction accuracy is a probability that the generated traffic takes the predicted value, and
the required resource calculation circuitry calculates the required occupation value and the required share value of each slice based on the predicted value and the probability.

6. The resource allocation device according to claim 5, wherein
the required resource calculation circuitry calculates a result obtained by multiplying the predicted value by the probability as the required occupation value, and calculates a result obtained by subtracting the required occupation value from the predicted value as the required share value.

7. The resource allocation device according to claim 1, wherein
the required resource calculation circuitry calculates, on the host pair basis, a total value of the required occupation value of each slice as the total required occupation value, and a total value of the required share value of each slice as the total required share value.

8. The resource allocation device according to claim 1, wherein
the required resource calculation circuitry calculates, on the host pair basis, a total value of the required occupation value of each slice as the total required occupation value, and a result obtained by multiplying an average value of the required share value of each slice by a coefficient according to the number of the slices to share the total required share value as the required share value.

9. The resource allocation device according to claim 1, wherein
the required resource calculation circuitry calculates, on the host pair basis, a total value of the required occupation value of each slice as the total required occupation value, and sets the required share value that is the largest among the required share value of each slice as the total required share value.

10. The resource allocation device according to claim 1, wherein
the required resource calculation circuitry calculates the required occupation value and the required share value based on a preset correspondence relation between the prediction accuracy and a resource allocation amount.

11. The resource allocation device according to claim 1, wherein
the required resource calculation circuitry performs weighting based on a request delay value on the required occupation value and the required share value that are calculated based on the predicted value and the prediction accuracy.

12. The resource allocation device according to claim 1, wherein
the required resource calculation circuitry performs weighting based on a request availability value on the required occupation value and the required share value that are calculated based on the predicted value and the prediction accuracy.

13. The resource allocation device according to claim 1, wherein
in a case where the total required occupation value and the total required share value are not allowed to be allocated, the resource allocation circuitry allocates the required occupation value to the slice selected based on the prediction accuracy, and allocates the available resource that remains after allocating the required occupation value to each slice remaining to which the required occupation value is not allocated.

14. The resource allocation device according to claim 13, wherein
in a case where the total required occupation value and the total required share value are not allowed to be allocated, the resource allocation circuitry allocates the required occupation value to the slice with the prediction accuracy higher than or equal to a predetermined threshold in order from the slice with the prediction accuracy that is high.

15. The resource allocation device according to claim 1, comprising
prediction accuracy calculation circuitry to calculate the prediction accuracy based on the predicted value of the traffic that is updated a plurality of times.

16. The resource allocation device according to claim 15, wherein
the prediction accuracy calculation circuitry calculates the mean of the predicted value and the standard deviation of the predicted value as the prediction accuracy based on the predicted value that is updated the plurality of times.

17. The resource allocation device according to claim 1, comprising
prediction accuracy calculation circuitry to calculate the prediction accuracy for each slice or the prediction accuracy for each combination of the slice and the host pair based on the predicted value of the traffic at a plurality of prediction times.

18. The resource allocation device according to claim 1, wherein
the prediction accuracy calculation circuitry calculates a moving average of the predicted value and the standard deviation of the predicted value as the prediction accuracy.

19. A resource allocation method to be executed by a resource allocation device that allocates a resource to each of one or more slices generated between a host pair that is a pair of a higher device and a lower device,
the resource allocation method comprising:
calculating, for each slice, a required occupation value and a required share value based on a predicted value and prediction accuracy of traffic generated in each of the one or more slices, and calculating a total required occupation value and a total required share value on a host pair basis based on the required occupation value and the required share value calculated, the required occupation value being a resource to be occupied and used by each slice, and the required share value being a resource to be shared and used between the slices; and
determining, for each of the host pair, whether or not the total required occupation value and the total required share value are allowed to be allocated to the host pair based on an available resource, and allocating the required occupation value and the required share value to each slice in a case where the allocation is possible.

20. A control circuit to control a resource allocation device that allocates a resource to each of one or more slices generated between a host pair that is a pair of a higher device and a lower device,
the control circuit causing the resource allocation device to execute:
calculating, for each slice, a required occupation value and a required share value based on a predicted value and prediction accuracy of traffic generated in each of the one or more slices, and calculating a total required occupation value and a total required share value on a host pair basis based on the required occupation value and the required share value calculated, the required occupation value being a resource to be occupied and used by each slice, and the required share value being a resource to be shared and used between the slices; and
determining, for each of the host pair, whether or not the total required occupation value and the total required share value are allowed to be allocated to the host pair based on an available resource, and allocating the required occupation value and the required share value to each slice in a case where the allocation is possible.
